(19) United States
(12) Patent Application Publication
(10) Pub. No.: US 2008/0008477 A1
(43) Pub. Date: Jan. 10, 2008

(54) Optical transmission between devices on circuit board

(75) Inventor: Toshio Ogawa, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/812,864

(22) Filed: Jun. 22, 2007

(30) Foreign Application Priority Data
Jul. 7, 2006 (JP) 2006-188067

(51) Int. Cl. H04B 10/00; G02B 6/42

(52) U.S. Cl. 398/164; 385/49

(57) ABSTRACT

A circuit board includes a substrate having a thickness in a first direction, extending in a plane perpendicular to the first direction, and having at least one of a through hole and a recess, and an optical transmission channel having an end thereof at a perimeter of the one of a through hole and a recess and having a portion thereof extending a predetermined distance from the end in a direction substantially perpendicular to the first direction, the portion being provided in the substrate or on a surface of the substrate.

### CROSS-REFERENCE TO RELATED APPLICATIONS

The present application is based upon and claims the benefit of priority from the prior Japanese Patent Application No. 2006-188067 filed on Jul. 7, 2006, with the Japanese Patent Office, the entire contents of which are incorporated herein by reference.

### BACKGROUND OF THE INVENTION

1. Field of the Invention

It is related to circuit boards, and is particularly related to a circuit board for providing an optical coupling to an optical device.

2. Description of the Related Art

At the present time, electronic devices such as semiconductor integrated circuits are implemented on printed circuit boards, and such device-mounted printed circuit boards are incorporated into apparatuses as modules or the like for providing desired functions. A printed circuit board is generally made by forming a circuit interconnect pattern of a conductive material such as copper foils on a resin substrate having an insulation property. Electronic devices and other electronic components (i.e., resistors, condensers, and the like) mounted on the board are electrically connected to each other via the circuit interconnect pattern.

The conductive material such as copper foil formed on the substrate has a problem in that its resistance causes a voltage drop, and that high frequency signals are difficult to propagate due to the effect of parasitic capacitance and parasitic inductance. Because of this, as transmission speed between electronic devices increases in response to the demand for printed circuit board modules having increased operation speed, signal transmission through conductive material such as copper foil may no longer be able to achieve desired transmission speed.

In consideration of this, it is conceivable to implement electronic devices on a circuit substrate and to provide optical couplings between these electronic devices. This configuration in which optical transmission provides signal transmission between electronic devices on a circuit board can provide a high-speed circuit board module for which signal transmission speed has no limiting effect. At present, however, there is no circuit board that is designed to provide optical couplings between devices on a substrate.

FIG. 1 is a drawing showing a surface-emitting semiconductor laser that is a typical example of a light emission device. A semiconductor laser 10 shown in FIG. 1 is formed by cleaving three-layered substrate that has an InGaAsP substrate 13 sandwiched between an InP p-type substrate 11 and an InP n-type substrate 12 and by forming mirror surfaces on the cleaved surfaces. In such a surface-emitting semiconductor laser, light is emitted in a lateral direction with respect to the substrate as shown by an arrow L in FIG. 1. Surface-emitting semiconductor lasers will likely continue to play a major role in the field of optical transmission in the future. Circuit boards for coupling devices through optical transmission will thus need to take into account the characteristics of semiconductor lasers that emit light in a lateral direction with respect to the substrate.

There are related-art documents such as Japanese Patent Application Publication No. 11-273816, Japanese Patent Application Publication No. 2003-29070, and Japanese Patent Application Publication No. 2003-315634.

Accordingly, there is a need for a circuit board having a structure suitable for optical transmission between optical devices while taking into account the characteristics of optical devices.

### SUMMARY OF THE INVENTION

It is a general object to provide a circuit board that substantially obviates one or more problems caused by the limitations and disadvantages of the related art.

Features and advantages will be presented in the description which follows, and in part will become apparent from the description and the accompanying drawings, or may be learned by practice of the invention according to the teachings provided in the description. Objects as well as other features and advantages will be realized and attained by a circuit board particularly pointed out in the specification in such full, clear, concise, and exact terms as to enable a person having ordinary skill in the art to practice the invention.

To achieve these and other advantages in accordance with the purpose, a circuit board includes a substrate having a thickness in a first direction, extending in a plane perpendicular to the first direction, and having at least one of a through hole and a recess, and an optical transmission channel having an end thereof at a perimeter of the one of a through hole and a recess and having a portion thereof extending a predetermined distance from the end in a direction substantially perpendicular to the first direction, the portion being provided in the substrate or on a surface of the substrate.

According to another aspect, a method of optically coupling semiconductor devices includes the steps of mounting on a substrate at least two semiconductor devices transmitting/receiving light in a lateral direction at a predetermined height position relative to a top surface of the substrate, disposing on the substrate an integrally formed member including a platform and an optical transmission channel formed on a top surface of the platform so as to position the optical transmission channel at the predetermined height position relative to the top surface of the substrate, and optically coupling between the two semiconductor devices through the optical transmission channel.

According to another aspect, a method of optically coupling semiconductor devices includes the steps of mounting on a first substrate at least two semiconductor devices transmitting/receiving light in a lateral direction at a predetermined height position relative to a top surface of the first substrate, stacking one or more second substrates on the first substrate, providing an optical transmission channel on a top surface of the one or more stacked second substrates so as to position the optical transmission channel at the predetermined height position relative to the top surface of the first substrate, and optically coupling between the two semiconductor devices through the optical transmission channel.

According to at least one embodiment, light emitted in a lateral direction relative to an optical device enters the optical transmission channel, with the optical device securely fit in the through hole or recess formed in the substrate. Namely, the optical transmission channel is formed such that the elevation (height position) of the point at which the optical device in the through hole or recess emits light becomes the same as the elevation (height position) of the optical transmission channel, and, also, the through hole or recess is formed at such a position that the two-dimensional position of the point at which the optical device emits light as viewed from above is aligned with the two-dimensional position of an end of the optical transmission channel. If no through hole and recess is provided on the substrate, there is a need to mount an optical device on the substrate first, and there is an additional need for a labor to subsequently attach an end of an optical fiber implemented on the surface of the substrate to the optical I/O cell of the already mounted optical device, for example. With the proposed arrangement, on the other hand, an optical coupling between the optical IO cell and the optical transmission channel can be securely made by simply fitting the optical device emitting light in a lateral direction to the recess of the substrate.

### BRIEF DESCRIPTION OF THE DRAWINGS

Other objects and further features of the present invention will be apparent from the following detailed description when read in conjunction with the accompanying drawings, in which:

FIG. 1 is a drawing showing a surface-emitting semiconductor laser that is a typical example of a light emission device;

FIG. 2 is a drawing showing a circuit board module according to a first embodiment of the present invention;

FIG. 3 is a drawing showing the configuration of an optical device shown in FIG. 2;

FIG. 4 is a drawing showing a plan view of the circuit board module of FIG. 2 as viewed from above;

FIG. 5 is a drawing showing a variation of the circuit board module;

FIG. 6 is a drawing showing the configuration of a circuit board module as a variation of the first embodiment of the present invention;

FIG. 7 is a drawing showing a plan view of the circuit board module of FIG. 6 as viewed from above;

FIG. 8 is a drawing showing a circuit board module according to a second embodiment of the present invention;

FIG. 9 is a drawing showing a plan view of the circuit board module of FIG. 8 as viewed from above;

FIG. 10 is a drawing showing a circuit board module according to a third embodiment of the present invention;

FIG. 11 is a drawing showing another example of the circuit board module;

FIG. 12 is a drawing showing the configuration of a variation of the circuit board module;

FIG. 13 is a drawing showing the configuration of another variation of the circuit board module;

FIG. 14 is a drawing showing a circuit board module according to a fourth embodiment of the present invention;

FIG. 15 is a drawing showing a plan view of the circuit board module of FIG. 14 as viewed from above;

FIGS. 16A and 16B are drawings showing an example of the configuration of an optical device used in the present invention;

FIG. 17 is a drawing showing a variation of the optical device;

FIGS. 18A and 18B are drawings showing another variation of the optical device;

FIG. 19 is a drawing showing another variation of the optical device;

FIG. 20 is a drawing showing a circuit board module according to a fifth embodiment of the present invention;

FIG. 21 is a drawing showing the configuration of an electrical/optical conversion device;

FIGS. 22A and 22B are drawings showing a circuit board module according to a sixth embodiment of the present invention;

FIG. 23 is a drawing showing a plan view of the circuit board module of FIG. 22 as viewed from above; and

FIGS. 24A through 24D are drawings for explaining an example of a method of optically coupling optical devices according to the present invention.

### DESCRIPTION OF THE PREFERRED EMBODIMENTS

In the following, embodiments of the present invention will be described with reference to the accompanying drawings.

FIG. 2 is a drawing showing a circuit board module according to a first embodiment of the present invention. In the description that follows, the entirety of a circuit board including optical devices that are implemented thereon is referred to as a circuit board module, and a circuit board on which no optical device is mounted is referred to as a circuit board.

A circuit board module 20 of FIG. 2 includes a substrate 21, an optical transmission channel 22, and an optical device (semiconductor device) 23. The substrate 21 may be a paper phenol substrate formed by soaking paper in phenol resin, a paper epoxy substrate formed by soaking paper in epoxy resin, a glass epoxy substrate formed by soaking layered glass cloth in epoxy resin, a Teflon substrate made of Teflon resin, or an alumina substrate made through alumina calcination. The substrate 21 is a rigid substrate that uses a nonflexible material as a base.

The substrate 21 has a recess 21a and a recess 21b formed therein. The optical transmission channel 22 is formed in the substrate 21 so as to connect between the recess 21a and the recess 21b. The optical transmission channel 22 may be a void space or an optical waveguide made of transparent material, and may be implemented by using an optical fiber. The substrate 21 having the recess 21a and the recess 21b and the optical transmission channel 22 constitute a circuit board. Optical devices are to be fit in the recesses 21a and 21b. In FIG. 2, the recess 21a has no optical device disposed therein in order to clearly illustrate the way the recess is formed.

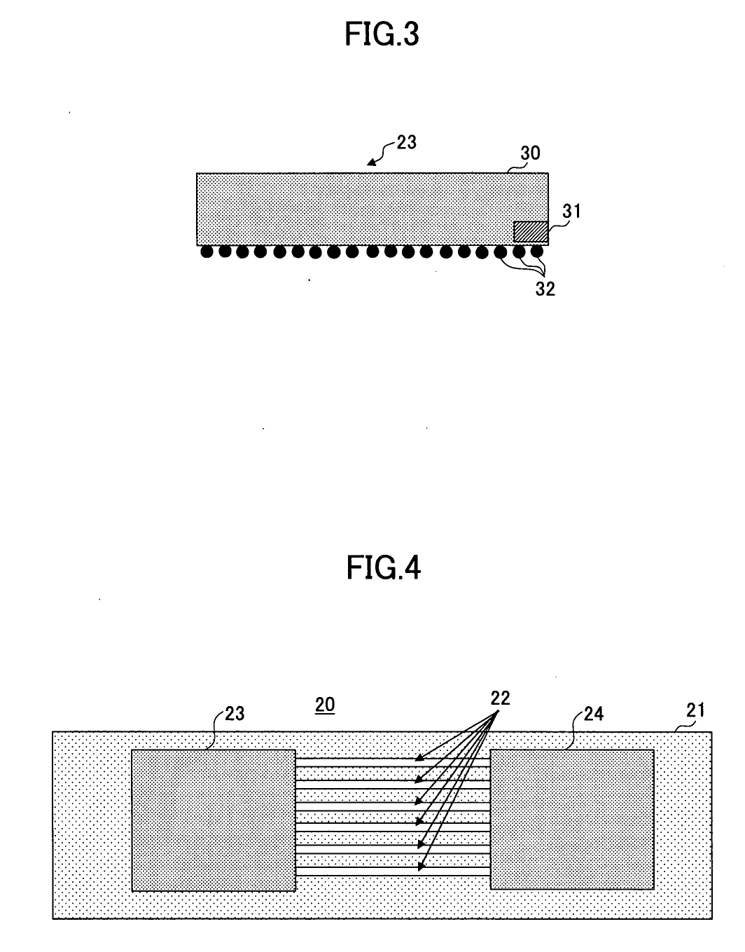

FIG. 3 is a drawing showing the configuration of the optical device (semiconductor device) 23. The optical device 23 shown in FIG. 3 includes a device core 30, an optical IO cell 31, and ball electrodes 32 comprised of a plurality of solder balls disposed on the bottom surface of the device. The device core 30 is a circuit portion that includes the circuit for achieving the intended function. The operation of this circuit may be that of conventional circuits based on the use of electrical signals. It should be noted, however, that the circuit does not have to be an electrical circuit, and may alternatively be an optical circuit that operates entirely on the use of optical signals.

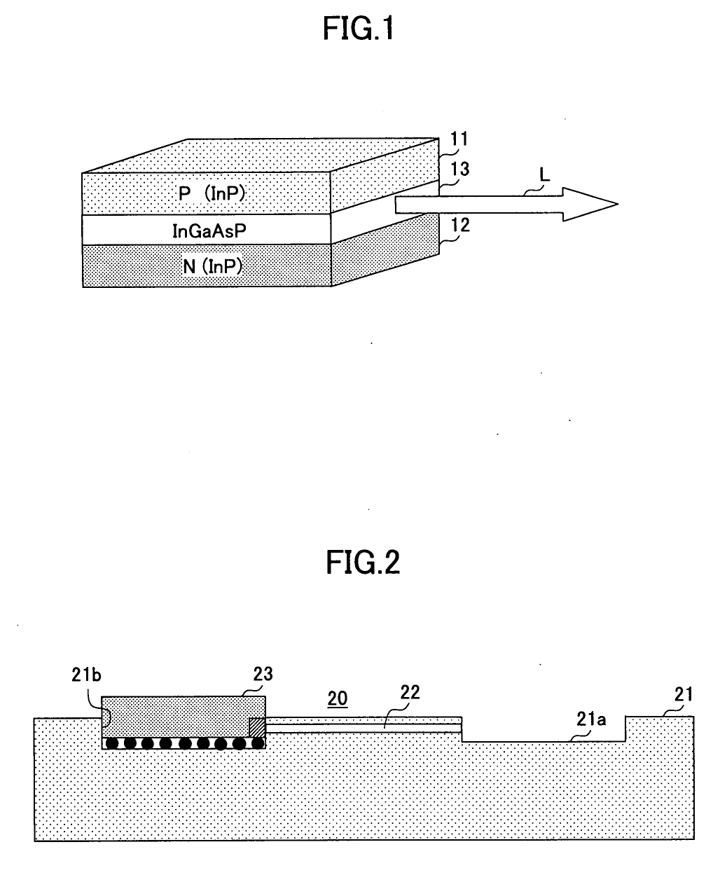

The optical IO cell 31 is an I/O portion provided for the purpose of allowing the device core 30 to exchange optical signals with external devices, and includes the semiconductor laser 10 as shown in FIG. 1. As the semiconductor laser 10 emits light in the lateral direction relative to the substrate, the optical IO cell 31 emits light also in a lateral direction relative to the optical device 23 (i.e., in a direction parallel to the plane of the planer-shape optical device 23). The optical IO cell 31 includes a light emitting part for transmitting light to an external device and a light receiving part for receiving light from an external device.

In this example, the optical device 23 is a BGA (Ball Grid Array) device. The ball electrodes 32 are provided for the purpose of supplying a power supply voltage and also for the purpose of signal inputs/outputs through electrical interfaces in addition to signal inputs/outputs through the optical IO cell 31. This makes it possible to transmit signals through interconnects comprised of conventional conductive material (e.g., copper foil) formed on the substrate 21 if there is no need to transmit these signals at high speed.

Referring back to FIG. 2, the depth of the recess 21b and the configuration of the optical device 23 are predetermined such that the position of the optical IO cell 31 of the optical device 23 is aligned with the position of the optical transmission channel 22 when the optical device 23 is securely fit in the recess 21b. Further, the recesses 21a and 21b have lengths and widths that are in agreement with the size of the optical devices fit therein.

FIG. 4 is a drawing showing a plan view of the circuit board module 20 as viewed from above. FIG. 4 illustrates a situation in which an optical device (semiconductor device) 24 is in the recess 21b. For the sake of convenience of explanation, the illustration is provided as if the optical transmission channel 22, which is buried in the substrate 21, was viewable through the substrate 21. Since the optical transmission channel 22 is buried in the substrate 21, the optical transmission channel 22 cannot be seen from above in reality.

As shown in FIG. 4, a plurality of optical transmission channels 22 may connect between the optical device 23 and the optical device 24 according to need. As previously described, the recesses 21a and 21b are formed such as to have lengths and widths that match the size of the optical devices fit therein, so that when viewed from above as in FIG. 4, there is no gap whatsoever between the substrate 21 and the optical devices 23 and 24. With such configuration that the recesses are formed to have the same size as the optical devices that are to be fit therein, the positioning of the optical devices can be accurately performed, thereby achieving reliable optical couplings between the optical IO cell 31 and the optical transmission channel 22.

FIG. 5 is a drawing showing a variation of the circuit board module 20. Like FIG. 4, FIG. 5 illustrates a plan view of the circuit board module 20 as viewed from above. The illustration is provided as if the optical transmission channel, which is buried in the substrate 21, was viewable through the substrate 21.

In FIG. 5, optical transmission channels comprised of optical fibers or the like that are bendable are used, thereby achieving curved signal transmission channels as opposed to straight line channels. Specifically, five optical transmission channels 22A running along curved parallel paths having the same shape are used to connect between the optical device 23 and the optical device 24, and an optical transmission channel 22B running along a curved path crossing the optical transmission channels 22A is also used for the connection. The optical transmission channel 22B may be disposed to cross over or under the optical transmission channels 22A. Since optical transmission channels such as optical fibers do not suffer crosstalk even when they are in physical contact with each other, there is no need to provide shielding or the like between the optical transmission channel 22B and the optical transmission channels 22A in the configuration shown in FIG. 5, allowing great latitude in the layout of the optical transmission channels.

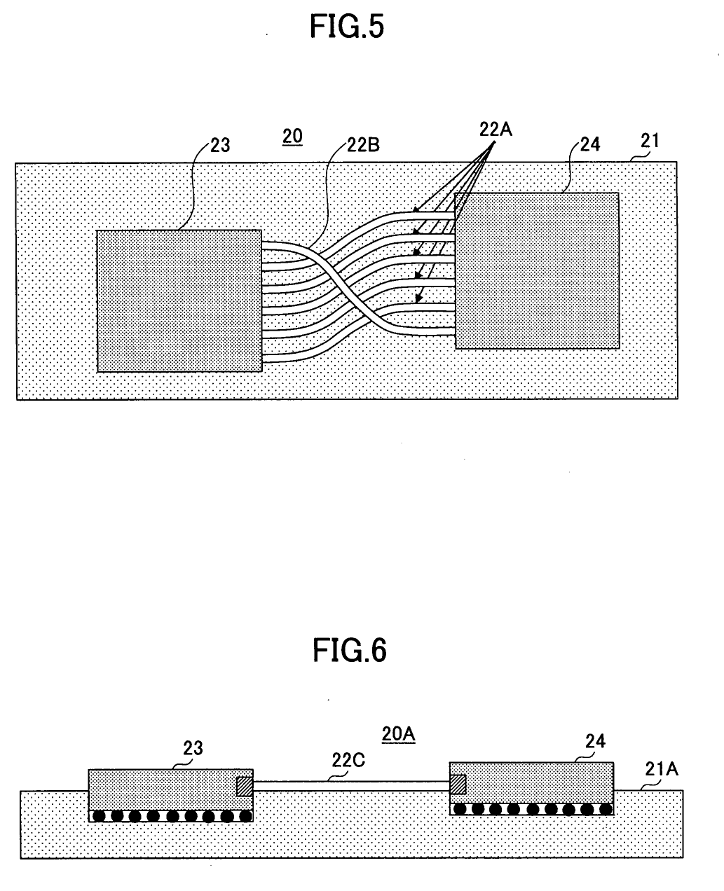

FIG. 6 is a drawing showing the configuration of a circuit board module as a variation of the first embodiment of the present invention. In FIG. 6, the same elements as those of FIG. 2 are referred to by the same numerals, and a description thereof will be omitted.

A circuit board module 20A of FIG. 6 includes a substrate 21A, an optical transmission channel 22C, an optical device 23, and an optical device 24. The substrate 21A is made of the same material as the substrate 21 shown in FIG. 2, and has recesses for receiving optical devices. The substrate 21A of FIG. 6 differs from the substrate 21 of FIG. 2 in that the optical transmission channel 22C is disposed on the surface of the substrate rather than buried in the substrate. The optical transmission channel 22C may be an optical waveguide made of transparent material, and may be implemented by using an optical fiber. In this manner, the optical transmission channel in the present invention may be formed on the surface of the substrate 21, rather than formed in the substrate 21.

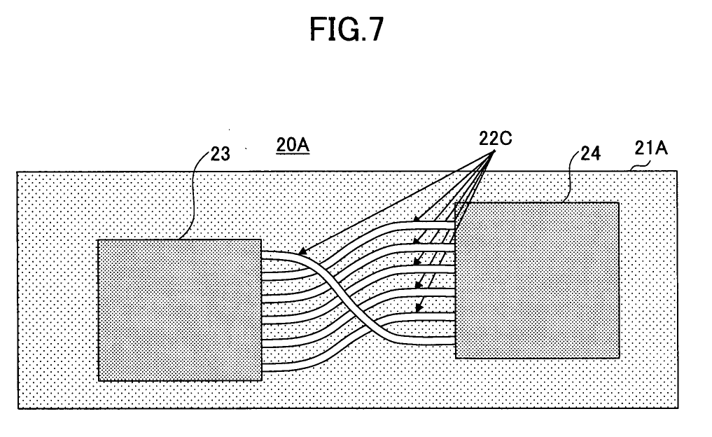

FIG. 7 is a drawing showing a plan view of the circuit board module 20A as viewed from above. In FIG. 7, the optical transmission channels 22C are disposed on the surface of the substrate 21A, so that the optical transmission channels 22C can actually be seen from above.

As shown in FIG. 7, there is no gap whatsoever between the optical devices 23 and 24 and the substrate 21A. With such configuration that the recesses are formed to have the same size as the optical devices that are to be fit therein, the positioning of the optical devices can be accurately performed, thereby achieving reliable optical couplings between the optical IO cell 31 and the optical transmission channel 22C.

Further, optical transmission channels comprised of optical fibers or the like that are bendable are used, thereby achieving curved signal transmission channels as opposed to straight line channels. In FIG. 7, the optical transmission channels 22C include five optical transmission channels running along curved parallel paths having the same shape and an optical transmission channel running along a curved path crossing these five optical transmission channels. The last optical transmission channel may be disposed to cross over or under the five optical transmission channels. Since optical transmission channels such as optical fibers do not suffer crosstalk even when they are in physical contact with each other, there is no need to provide shielding or the like between the optical transmission channels in the configuration shown in FIG. 7, allowing great latitude in the layout of the optical transmission channels. Needless to say, the optical transmission channels 22C may be disposed along straight lines to connect between the optical device 23 and the optical device 24 as in the configuration shown in FIG. 4.

The first embodiment of the present invention as described above includes a substrate having a thickness in a first direction, extending in a plane perpendicular to the first direction, and having a recess, and an optical transmission channel having an end thereof at a perimeter of the recess and having a portion thereof extending a predetermined distance from such an end in a direction substantially perpendicular to the first direction, the portion being provided in the substrate or on the surface of the substrate. An optical device is fit in the recess of the substrate, and is positioned in the first direction by the bottom surface of the recess.

According to the provision described above, light emitted in a lateral direction to the optical device enters the optical transmission channel, with the optical device securely fit in the recess of the substrate. Namely, the recess is formed to have such a depth that the elevation (height position) of the point at which the optical device emits light becomes the same as the elevation (height position) of the optical transmission channel, and, also, the recess is formed at such a position that the two-dimensional position of the point at which the optical device emits light as viewed from above is aligned with the two-dimensional position of an end of the optical transmission channel. If no recess is provided on the substrate, there is a need to mount an optical device on the substrate first, and there is an additional need for a labor to subsequently attach an end of an optical fiber implemented on the surface of the substrate to the optical I/O cell of the already mounted optical device, for example. With the arrangement of the present invention, on the other hand, an optical coupling between the optical IO cell and the optical transmission channel can be securely made by simply fitting the optical device emitting light in a lateral direction to the recess of the substrate.

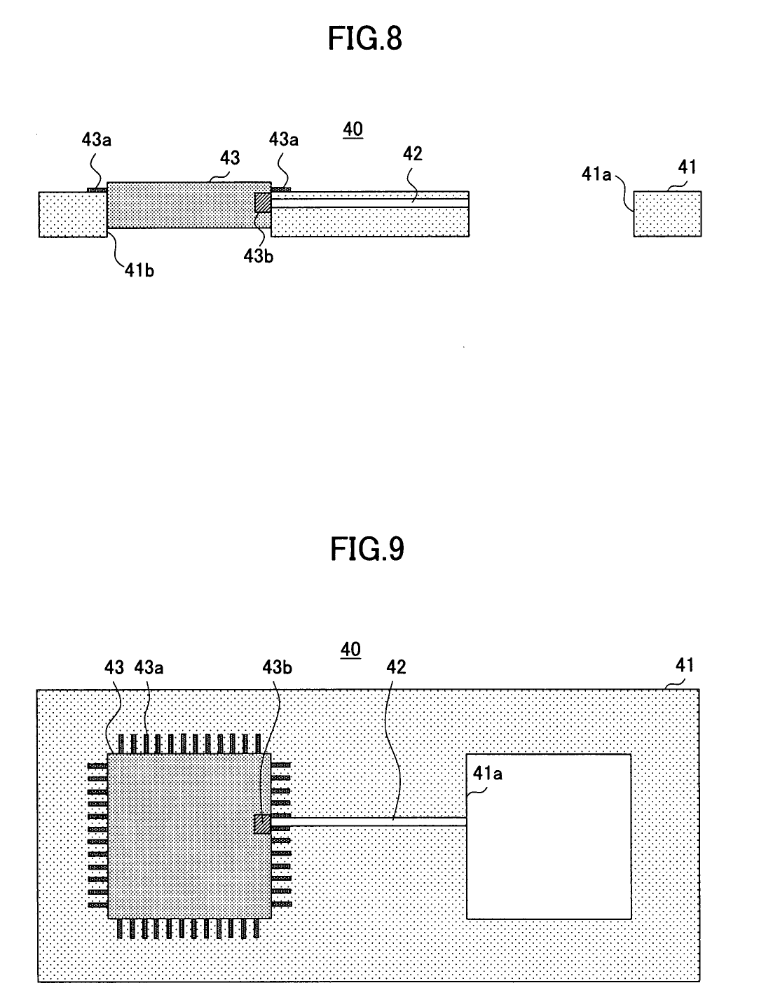

FIG. 8 is a drawing showing a circuit board module according to a second embodiment of the present invention.

A circuit board module 40 of FIG. 8 includes a substrate 41, an optical transmission channel 42, and an optical device 43. The substrate 41 is made of the same or similar material to that of the substrate 21 shown in FIG. 2. The substrate 41 of FIG. 8 differs from the substrate 21 of FIG. 2 in that through holes 41a and 41b are formed in place of the recesses 21a and 21b in order to accommodate optical devices.

The optical transmission channel 42 is formed in the substrate 41 so as to connect between the through hole 41a and the through hole 41b. The optical transmission channel 42 may be a void space or an optical waveguide made of transparent material, and may be implemented by using an optical fiber. The substrate 41 having the through hole 41a and the through hole 41b and the optical transmission channel 42 constitute a circuit board. Optical devices are to be fit in the through holes 41a and 41b. In FIG. 8, the through hole 41a has no optical device disposed therein in order to clearly illustrate the way the through hole is formed.

The optical device 43 has lead terminals 43a extending in all the four directions from the core portion of the optical device 43, and also has an optical IO cell 43b. The optical device 43 includes the circuit for achieving the intended function. The operation of this circuit may be that of conventional circuits based on the use of electrical signals. It should be noted, however, that the circuit does not have to be an electrical circuit, and may alternatively be an optical circuit that operates entirely on the use of optical signals.

The optical IO cell 43b is an I/O portion provided for the purpose of allowing the circuit of the optical device 43 to exchange optical signals with external devices, and includes the semiconductor laser 10 as shown in FIG. 1. As the semiconductor laser 10 emits light in the lateral direction relative to the substrate, the optical IO cell 43b emits light also in a lateral direction relative to the optical device 43 (i.e., in a direction parallel to the plane of the planer-shape optical device 43). The optical IO cell 43b includes a light emitting part for transmitting light to an external device and a light receiving part for receiving light from an external device.

In this example, the optical device 43 is a QFP (Quad Flat Package) device. The optical device 43 is fit in the through hole 41b of the substrate 41 in such a position that the device is flipped upside down compared to the position in which a QFP device is implemented on a conventional substrate. The lead terminals 43a are pressed against the perimeter surface of the through hole 41b for positioning, and are electrically connected to interconnects provided on the surface of the substrate 41. The lead terminals 43a are provided for the purpose of supplying a power supply voltage and also for the purpose of signal inputs/outputs through electrical interfaces in addition to signal inputs/outputs through the optical IO cell 43b. This makes it possible to transmit signals through interconnects comprised of conventional conductive material (e.g., copper foil) formed on the substrate 41 if there is no need to transmit these signals at high speed.

FIG. 9 is a drawing showing a plan view of the circuit board module 40 as viewed from above. For the sake of convenience of explanation, the illustration is provided as if the optical transmission channel 42, which is buried in the substrate 41, was viewable through the substrate 41. Since the optical transmission channel 42 is buried in the substrate 41, the optical transmission channel 42 cannot be seen from above in reality.

As shown in FIG. 9, the through holes 41a and 41b are formed such as to have lengths and widths that match the size of the optical devices fit therein, so that when viewed from above as in FIG. 9, there is no gap whatsoever between the substrate 41 and the optical device 43. With such configuration that the through holes are formed to have the same size as the optical devices that are to be fit therein, the positioning of the optical devices can be accurately performed, thereby achieving reliable optical couplings between the optical IO cell 43b and the optical transmission channel 42.

It should be noted that in the second embodiment shown in FIG. 8 and FIG. 9, a plurality of optical transmission channels may be provided to connect between optical devices, may be bent, or may be disposed to cross over/under each other as in the first embodiment.

The second embodiment of the present invention as described above includes a substrate having a thickness in a first direction, extending in a plane perpendicular to the first direction, and having a through hole, and an optical transmission channel having an end thereof at a perimeter of the through hole and having a portion thereof extending a predetermined distance from such an end in a direction substantially perpendicular to the first direction, the portion being provided in the substrate or on the surface of the substrate. An optical device is fit in the through hole of the substrate, and is positioned in the first direction by the frame surface (perimeter surface) of the through hole.

According to the provision described above, light emitted in a lateral direction to the optical device enters the optical transmission channel, with the optical device securely fit in the through hole of the substrate. Namely, the optical transmission channel is formed at such a depth that the elevation (height position) of the point at which the optical device emits light becomes the same as the elevation (height position) of the optical transmission channel, and, also, the through hole is formed at such a position that the two-dimensional position of the point at which the optical device emits light as viewed from above is aligned with the two-dimensional position of an end of the optical transmission channel. If no through hole is provided on the substrate, there is a need to mount an optical device on the substrate first, and there is an additional need for a labor to subsequently attach an end of an optical fiber implemented on the surface of the substrate to the optical I/O cell of the already mounted optical device, for example. With the arrangement of the present invention, on the other hand, an optical coupling between the optical IO cell and the optical transmission channel can be securely made by simply fitting the optical device emitting light in a lateral direction to the through hole of the substrate.

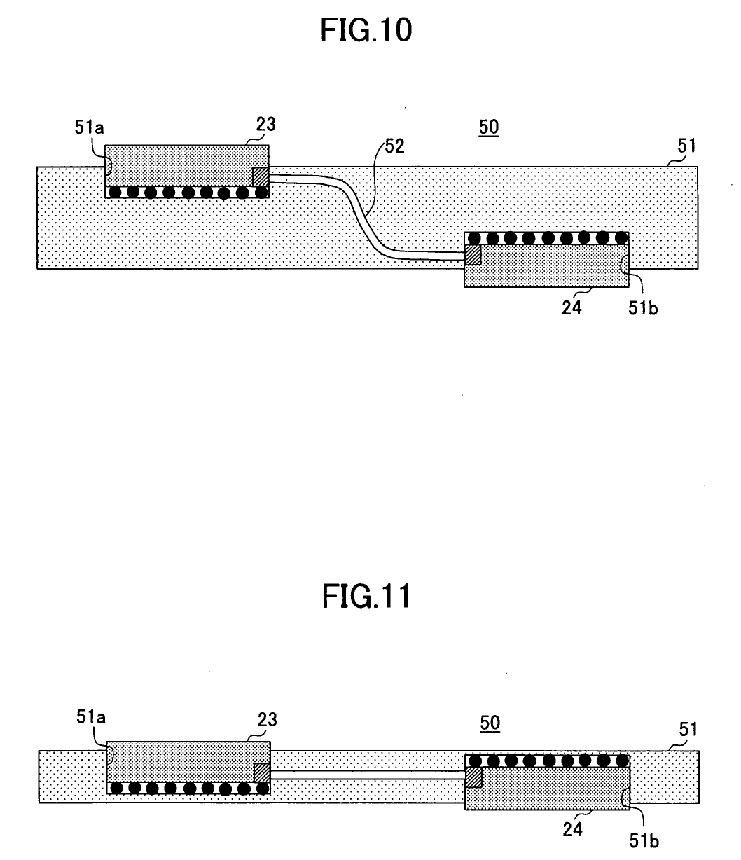

FIG. 10 is a drawing showing a circuit board module according to a third embodiment of the present invention. In FIG. 10, the same elements as those of FIG. 2 and FIG. 6 are referred to by the same numerals, and a description thereof will be omitted.

A circuit board module 50 of FIG. 10 includes a substrate 51, an optical transmission channel 52, an optical device 23, and an optical device 24. The substrate 51 has the same configuration as the substrate 21 of FIG. 2, except that recesses 51a and 51b for accommodating optical devices are formed on the top surface and the bottom surface, respectively, of the substrate 51.

The optical transmission channel 52 is formed in the substrate 51 so as to connect between the recesses 51a and 51b. The optical transmission channel 52 may be an optical waveguide made of transparent material, and may be implemented by using an optical fiber. The substrate 51 having the recesses 51a and 51b and the optical transmission channel 52 constitute a circuit board. The optical devices 23 and 24 are fit in the recesses 51a and 51b, respectively. In the example shown in FIG. 10, the optical transmission channel 52 is formed to curve in the substrate 51, so that the optical transmission channel 52 extends from a point near one surface of the substrate 51 to a point near the other surface of the substrate 51 such as to go across the substrate 51 in its thickness direction.

FIG. 11 is a drawing showing another example of the circuit board module 50. In FIG. 11, the same elements as those of FIG. 10 are referred to by the same numerals, and a description thereof will be omitted.

In the example shown in FIG. 11, the thickness of the substrate 51 is relatively thin. Because of this, the optical IO cells of the optical devices are so positioned to face each other when the optical devices 23 and 24 are fit in the recesses 51a and 51b formed in the top and bottom surfaces of the substrate 51, respectively. In this example, thus, the optical transmission channel 52 is formed along a straight path in the substrate 51.

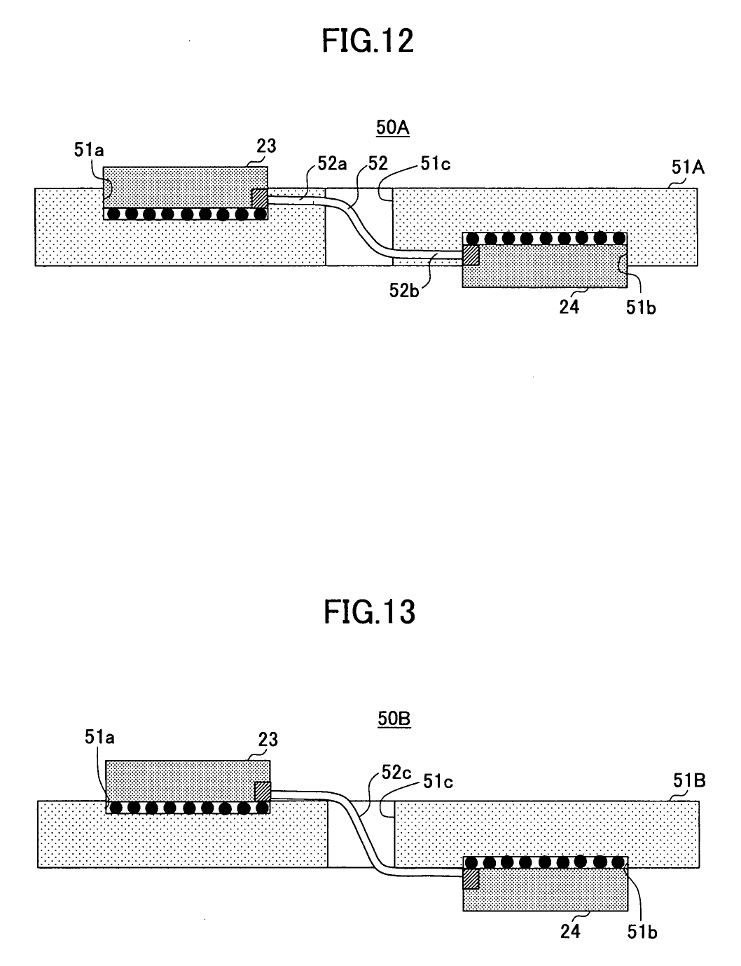

FIG. 12 is a drawing showing the configuration of a variation of the circuit board module 50. In FIG. 12, the same elements as those of FIG. 10 are referred to by the same numerals, and a description thereof will be omitted.

A circuit board module 50A of FIG. 12 includes a substrate 51A, an optical transmission channel 52, an optical device 23, and an optical device 24. The substrate 51A has the same configuration as the substrate 51 shown in FIG. 10, except that a further through hole 51c is provided between the through hole 51a accommodating the optical device 23 and the through hole 51b accommodating the optical device 24.

The optical transmission channel 52 curves in the through hole 51c so as to extend from a point near one surface of the substrate 51A to a point near the other surface of the substrate 51A such as to go across the substrate 51A in its thickness direction. The portion 52a of the optical transmission channel 52 that is buried in the substrate 51A near the through hole 51a extends along a straight path, and is disposed at a constant depth in the substrate 51A. Further, the portion 52b of the optical transmission channel 52 that is buried in the substrate 51A near the through hole 51b extends along a straight path, and is disposed at a constant depth in the substrate 51A.

In this manner, the optical transmission channels 52a and 52b buried in the substrate 51A are formed along straight paths at the respective constant depths, so that the manufacturing of the substrate 51A is easier than when a curved channel having varying depth positions in the substrate needs to be formed as in the case of FIG. 10.

FIG. 13 is a drawing showing the configuration of another variation of the circuit board module 50. In FIG. 13, the same elements as those of FIG. 12 are referred to by the same numerals, and a description thereof will be omitted.

A circuit board module 50B of FIG. 13 includes a substrate 51B, an optical transmission channel 52c, an optical device 23, and an optical device 24. The substrate 51B has substantially the same configuration as the substrate 51A of FIG. 12, but differs from the substrate 51A of FIG. 12 in that the optical transmission channel 52c is disposed on the surface of the substrate rather than buried in the substrate. The optical transmission channel 52c may be an optical waveguide made of transparent material, and may be implemented by using an optical fiber. The optical transmission channel 52c passes through the through hole 51c so as to extend from one surface of the substrate 51B to the other surface of the substrate 51B such as to go across the substrate 51B in its thickness direction.

FIG. 14 is a drawing showing a circuit board module according to a fourth embodiment of the present invention. A circuit board module 60 of FIG. 14 is a multi-chip package that is mountable on another circuit board.

A circuit board module 60 of FIG. 14 includes a substrate 61, an optical transmission channel 62, an optical device 63, an optical device 64, a mold 65, and ball electrodes 66. The substrate 61, the optical transmission channel 62, the optical device 63, and the optical device 64 are identical to the substrate 21, the optical transmission channel 22, the optical device 23, and the optical device 24, respectively, which have been previously described, and the descriptions thereof provided in connection with the first embodiment and its variations and examples also apply to these elements.

In the fourth embodiment shown in FIG. 14, the optical devices 63 and 64 are fit in recesses in the substrate 61, and are coupled to each other via the optical transmission channel 62. Further, the mold 65 made of resin or the like is provided on the substrate 61 so as to seal the optical transmission channel 62, the optical device 63, and the optical device 64. The circuit board module 60 configured as described above as a multi-chip package has the ball electrodes 66 for transmitting/receiving of electrical signals to/from an external device, and may be implemented on another circuit board.

Since the mold 65 completely covers the optical transmission channel 62, the optical device 63, and the optical device 64, there is no risk of having the optical transmission channel 62 damaged even though the optical transmission channel 62 is disposed on the surface of the substrate 61 rather than buried in the substrate 61. Accordingly, cost reduction is achieved by using the configuration that has the optical transmission channel 62 on the substrate 61 and is thus easier to manufacture, rather than using the configuration that has the optical transmission channel 62 buried in the substrate 61. Needless to say, the configuration having the optical transmission channel 62 buried in the substrate 61 may as well be used.

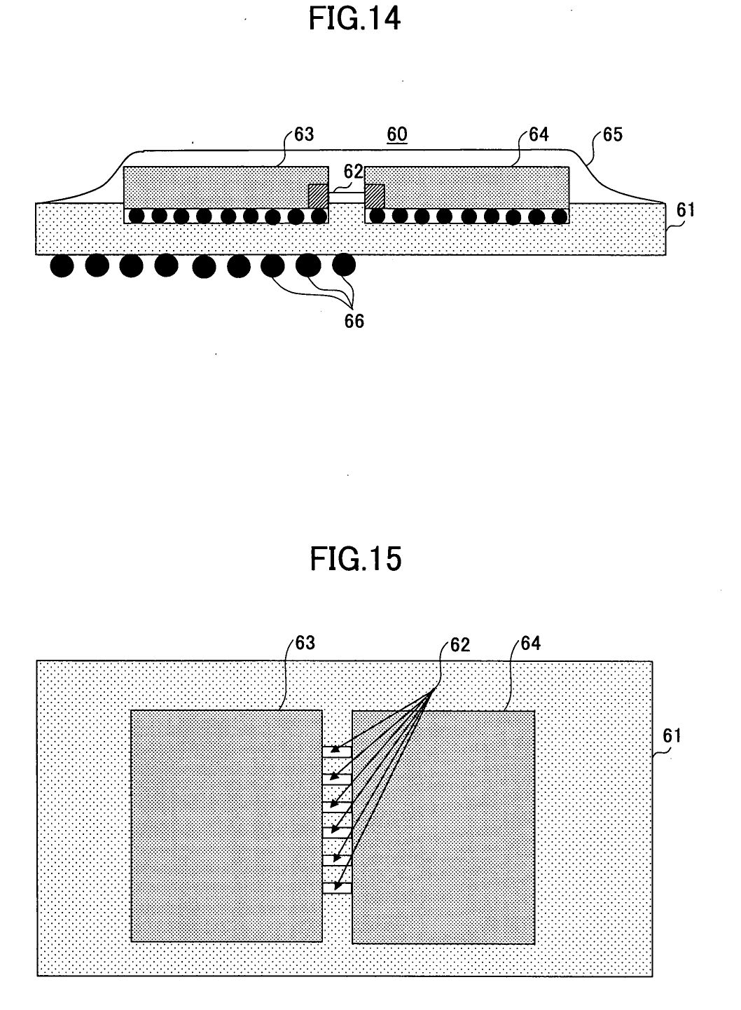

FIG. 15 is a drawing showing a plan view of the circuit board module 60 as viewed from above. For the sake of convenience of explanation, the illustration is provided as if the optical transmission channel 62, which is disposed on the substrate 61, was viewable through the mold 65. If the mold 65 is opaque, the optical transmission channel 62 cannot be seen from above in reality.

As shown in FIG. 15, a plurality of optical transmission channels 62 may connect between the optical device 63 and the optical device 64 according to need. As previously described, the recesses are formed such as to have lengths and widths that match the size of the optical devices fit therein, so that when viewed from above as in FIG. 15, there is no gap whatsoever between the substrate 61 and the optical devices 63 and 64.

In the fourth embodiment described above, the circuit board module of the present invention is provided with the ball electrodes, thereby forming a multi-chip module that has internal electronic devices optically communicating with each other. The multi-chip module configured in this manner may be implemented to operate on another circuit board.

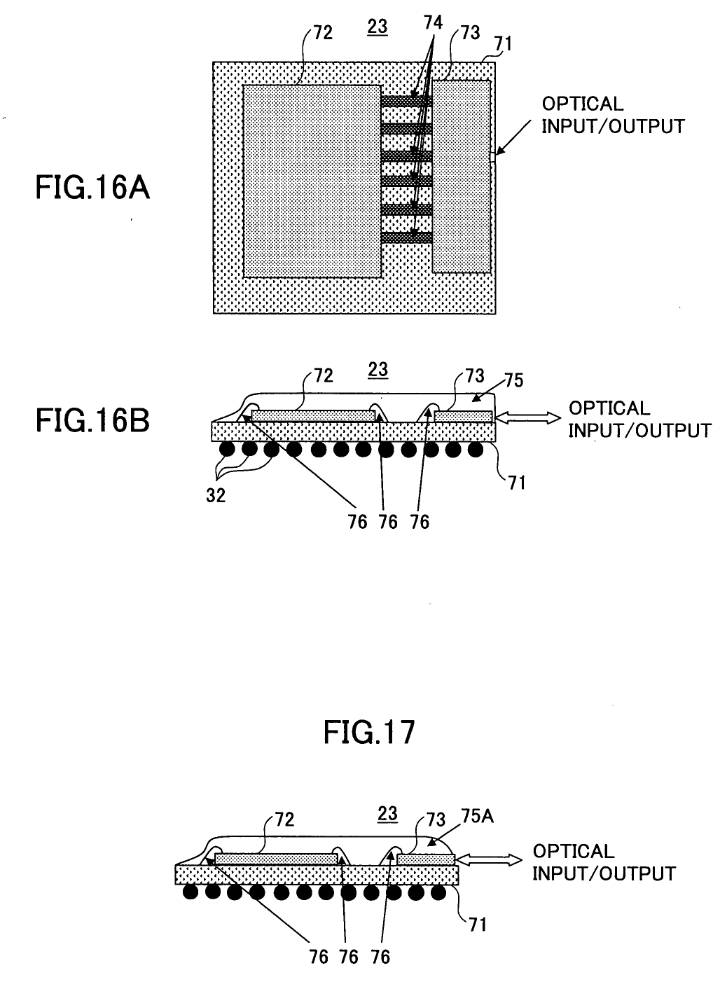

FIGS. 16A and 16B are drawings showing an example of the configuration of an optical device used in the present invention. FIG. 16A shows a plan view of the optical device 23, and FIG. 16B shows a cross-sectional view of the optical device 23 as viewed from the side. The optical device 23 is identical to the one that is implemented on the circuit board module 20 as shown in FIG. 2.

The optical device 23 includes a package substrate 71, a CMOSLSI 72, an electrical/optical converting device 73, interconnects 74, a transparent mold 75, and ball electrodes 32.

The CMOSLSI 72 and the electrical/optical converting device 73 are disposed on the package substrate 71. Electrical couplings with the package substrate 71 are provided through bonding wires 76, for example. Alternatively, the CMOSLSI 72 and the electrical/optical converting device 73 having a BGA structure or QFP structure may be used. The interconnects 74 are formed on the package substrate 71 to electrically connect between the CMOSLSI 72 and the electrical/optical converting device 73. The transparent mold 75 is transparent resin or the like disposed on/over the top surface of the package substrate 71, and seals all the CMOSLSI 72, the electrical/optical converting device 73, the interconnects 74, the bonding wires 76, and so on.

The electrical/optical converting device 73 performs electrical/optical signal conversion between electrical signals exchanged with the CMOSLSI 72 and optical signals exchanged with an external device. The CMOSLSI 72 is a CMOS circuit device that operates solely based on electrical signals. The electrical/optical converting device 73 serves to perform electrical/optical signal conversion and has a serialize/de-serialize function that performs serial/parallel conversion between serial data (optical signals) exchanged with an external device and parallel data (electrical signals) exchanged with the CMOSLSI 72 via the interconnects 74. The serial/parallel conversion function is not necessarily a required function, and mere electrical/optical signal conversion may suffice for the purpose. Since the transparent mold 75 is a transparent material, the electrical/optical converting device 73 can exchange optical signals with an external device despite the fact that the electrical/optical converting device 73 is sealed with the transparent mold 75.

FIG. 17 is a drawing showing a variation of the optical device 23. In FIG. 17, the same elements as those of FIG. 16 are referred to by the same numerals, and a description thereof will be omitted.

In the optical device 23 of FIG. 17, the transparent mold 75 shown in FIG. 16B is replaced with an opaque mold 75A. Other parts of the configuration are the same between FIG. 17 and FIG. 16B. In the example shown in FIG. 17, opaque resin or other material, rather than transparent resin or other material, is used for the opaque mold 75A, so that complete sealing of the electrical/optical converting device 73 would prevent optical inputting/outputting. As shown in FIG. 17, thus, the optical input/output portion is exposed without being sealed with the opaque mold 75A. Such configuration may also provide the optical device 23 for use in the present invention.

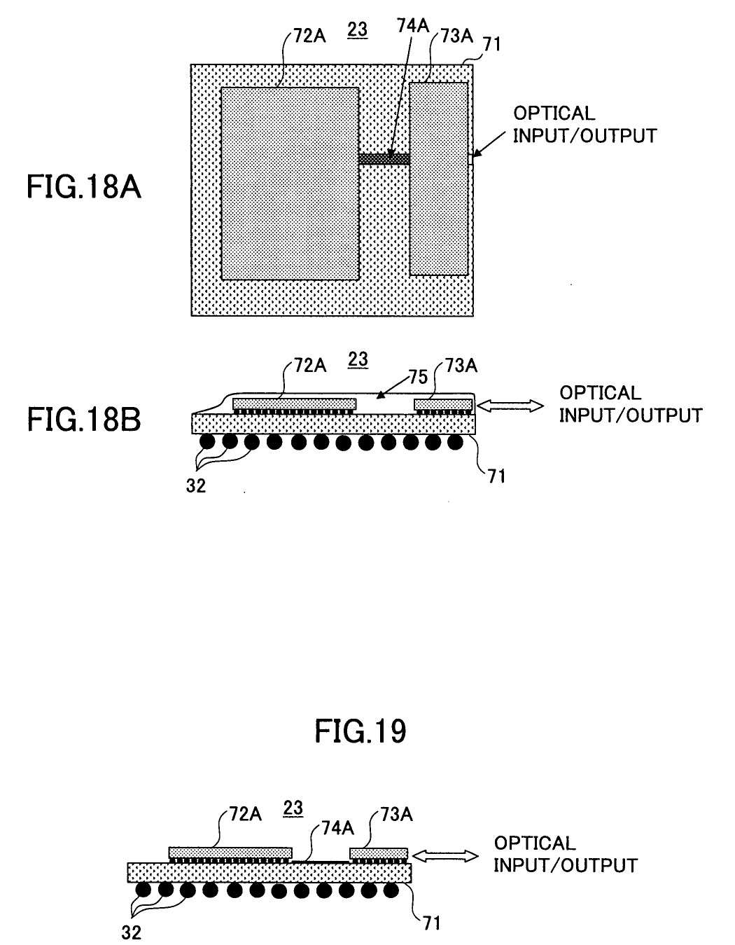

FIGS. 18A and 18B are drawings showing another variation of the optical device 23. In FIGS. 18A and 18B, the same elements as those of FIG. 16 are referred to by the same numerals, and a description thereof will be omitted.

FIG. 18A shows a plan view of the optical device 23, and FIG. 18B shows a cross-sectional view of the optical device 23 as viewed from the side. The optical device 23 is identical to the one that is implemented on the circuit board module 20 as shown in FIG. 2.

The optical device 23 includes a package substrate 71, a CMOSLSI 72A, an electrical/optical converting device 73A, an interconnect 74A, a transparent mold 75, and ball electrodes 32.

The CMOSLSI 72A and the electrical/optical converting device 73A are disposed on the package substrate 71. In this example, the CMOSLSI 72A and the electrical/optical converting device 73A have a BGA structure or the like, and are electrically connected to the package substrate 71 through flip-chip implementation. The interconnect 74A is formed on the package substrate 71 to electrically connect between the CMOSLSI 72A and the electrical/optical converting device 73A. The transparent mold 75 is transparent resin or the like disposed on/over the top surface of the package substrate 71, and seals all the CMOSLSI 72A, the electrical/optical converting device 73A, the interconnect 74A, and so on.

The electrical/optical converting device 73A performs electrical/optical signal conversion between electrical signals exchanged with the CMOSLSI 72A and optical signals exchanged with an external device. Signal transmission with the CMOSLSI 72A is performed through high-speed short-distance electrical signals. Since the transparent mold 75 is a transparent material, the electrical/optical converting device 73A can exchange optical signals with an external device despite the fact that the electrical/optical converting device 73A is sealed with the transparent mold 75.

FIG. 19 is a drawing showing another variation of the optical device 23. In FIG. 19, the same elements as those of FIGS. 18A and 18B are referred to by the same numerals, and a description thereof will be omitted.

In the optical device 23 of FIG. 19, the transparent mold 75 shown in FIG. 18B is removed. Other parts of the configuration are the same between FIG. 19 and FIG. 18B. Such bare-chip configuration may also provide the optical device 23 for use in the present invention.

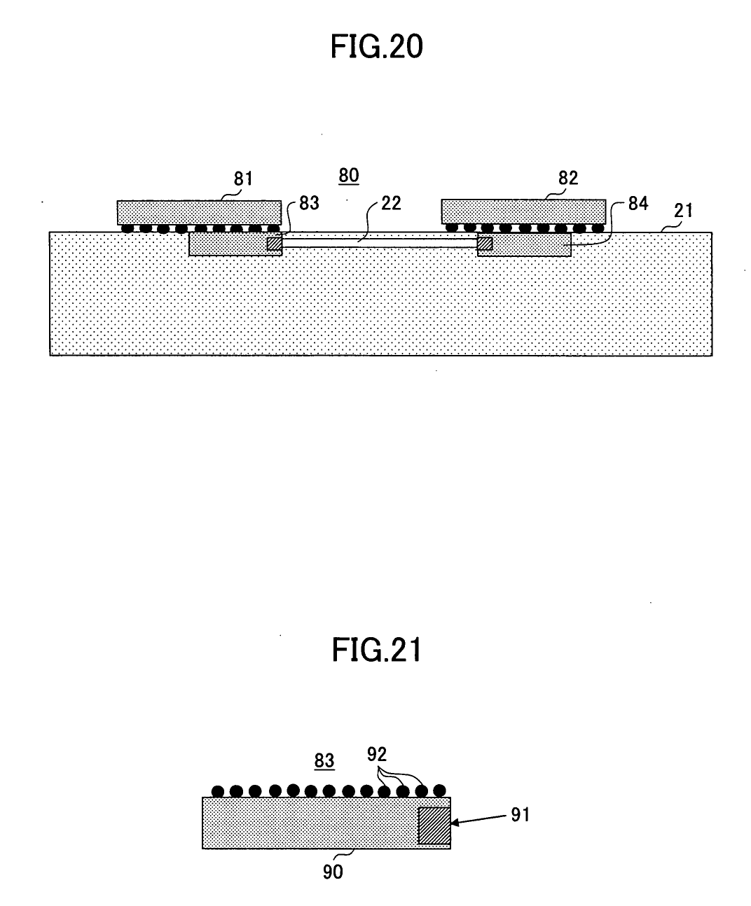

FIG. 20 is a drawing showing a circuit board module according to a fifth embodiment of the present invention. In FIG. 20, the same elements as those of FIG. 2 are referred to by the same numerals, and a description thereof will be omitted.

A circuit board module 20 of FIG. 20 includes a substrate 21, an optical transmission channel 22, a CMOS device 81, a CMOS device 82, an electrical/optical conversion device 83, and an electrical/optical conversion device 84. The electrical/optical conversion devices 83 and 84 are fit in recesses formed in the substrate 21 with their circuit surface facing upward, and the CMOS devices 81 and 82 are disposed thereon such as to face the circuit surface of the electrical/optical conversion devices 83 and 84, respectively. The CMOS device 81 is a BGA type, and some of its ball electrodes are connected to electrodes provided on the surface of the substrate 21. The remaining ball electrodes are shared with the electrical/optical conversion device 83. By the same token, the CMOS device 82 is a BGA type, and some of its ball electrodes are connected to electrodes provided on the surface of the substrate 21. The remaining ball electrodes are shared with the electrical/optical conversion device 84.

FIG. 21 is a drawing showing the configuration of the electrical/optical conversion device 83. The electrical/optical conversion device 84 has the same configuration. The electrical/optical conversion device 83 shown in FIG. 21 includes a device core 90, an optical IO cell 91, and ball electrodes 92 comprised of a plurality of solder balls disposed on the circuit surface of the device. The ball electrodes 92 are electrically connected to the CMOS device 81 so that the electrical/optical conversion device 83 and the CMOS device 81 share the ball electrodes 92 to exchange electrical signals. The device core 90 is a circuit portion that includes the circuit for achieving the electrical/optical conversion function.

The optical IO cell 91 is an I/O portion driven by the device core 90 for the purpose of exchanging optical signals with external devices, and includes the semiconductor laser 10 as shown in FIG. 1. As the semiconductor laser 10 emits light in the lateral direction relative to the substrate, the optical IO cell 91 emits light also in a lateral direction relative to the electrical/optical conversion device 83 (i.e., in a direction parallel to the plane of the planer-shape electrical/optical conversion device 83). The optical IO cell 91 includes a light emitting part for transmitting light to an external device and a light receiving part for receiving light from an external device.

In the fifth embodiment of the present invention described above, electrical/optical conversion devices are fit in recesses formed in the substrate, and CMOS devices are disposed such as to have their circuit surfaces facing the electrical/optical conversion devices, thereby performing signal transmission between the electrical/optical conversion devices and the CMOS devices. Further, the circuit board and the electrical/optical conversion devices are configured such that light emitted in a lateral direction relative to an electrical/optical conversion device enters an optical transmission channel, with this electrical/optical conversion device securely fit in a recess of the substrate. Namely, the recess is formed to have such a depth that the elevation (height position) of the point at which the electrical/optical conversion device emits light becomes the same as the elevation (height position) of the optical transmission channel, and, also, the recess is formed at such a position that the two-dimensional position of the point at which the electrical/optical conversion device emits light as viewed from above is aligned with the two-dimensional position of an end of the optical transmission channel. With this configuration, an optical coupling between the optical IO cell and the optical transmission channel can be securely made by simply fitting the electrical/optical conversion device emitting light in a lateral direction to the recess of the substrate. Further, optical transmission between conventional CMOS devices is provided by connecting electrical/optical conversion devices to the CMOS devices without using dedicated optical devices.

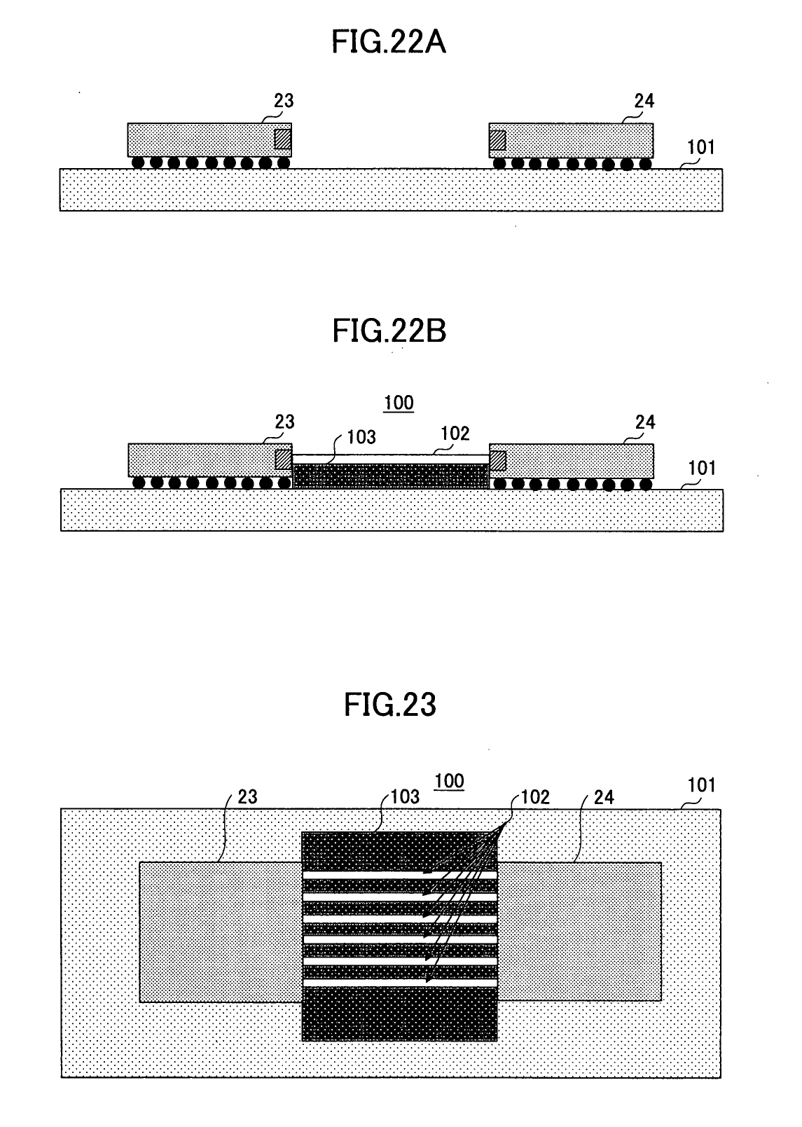

FIGS. 22A and 22B are drawings showing a circuit board module according to a sixth embodiment of the present invention. In FIGS. 22A and 22B, the same elements as those of FIG. 2 are referred to by the same numerals, and a description thereof will be omitted.

FIG. 22A shows a configuration in which the optical device 23 and the optical device 24 are implemented on a substrate 101. The optical devices 23 and 24 are electrically connected to the substrate 101 by utilizing a conventional electrical coupling structure such as a BGA structure.

FIG. 22B shows a circuit board module 100 made by disposing, on the substrate 101 between the optical device 23 and the optical device 24, an integral structure including a substrate platform 103 and an optical transmission channel 102 disposed on the top surface of the substrate platform 103. When compared with the top surface of the substrate platform 103, the elevation (vertical position) of the optical device 23 and the optical device 24 is at a lowered level as if they were fit in recesses, so that the optical transmission channel 102 disposed on the top surface of the substrate platform 103 has the elevation thereof aligned with the elevation of the optical IO cells of the optical devices 23 and 24.

FIG. 23 is a drawing showing a plan view of the circuit board module 100 as viewed from above. As shown in FIG. 23, a plurality of optical transmission channels 102 may connect between the optical device 23 and the optical device 24 according to need. The substrate platform 103 on which the optical transmission channels 102 are disposed has a rectangular shape in this example, and is positioned between the optical device 23 and the optical device 24.

The configuration of the sixth embodiment as described above can align the vertical position of the optical transmission channels 102 with the vertical position of the point of light emission of the optical devices 23 and 24 so as to easily achieve optical transmission between the optical device 23 and the optical device 24. In so doing, what needs to be done is to dispose, between the optical devices, an integral structure (or member, or component) having the optical transmission channel disposed on the top surface of a substrate platform. Optical coupling between the optical devices can thus be relatively easily achieved.

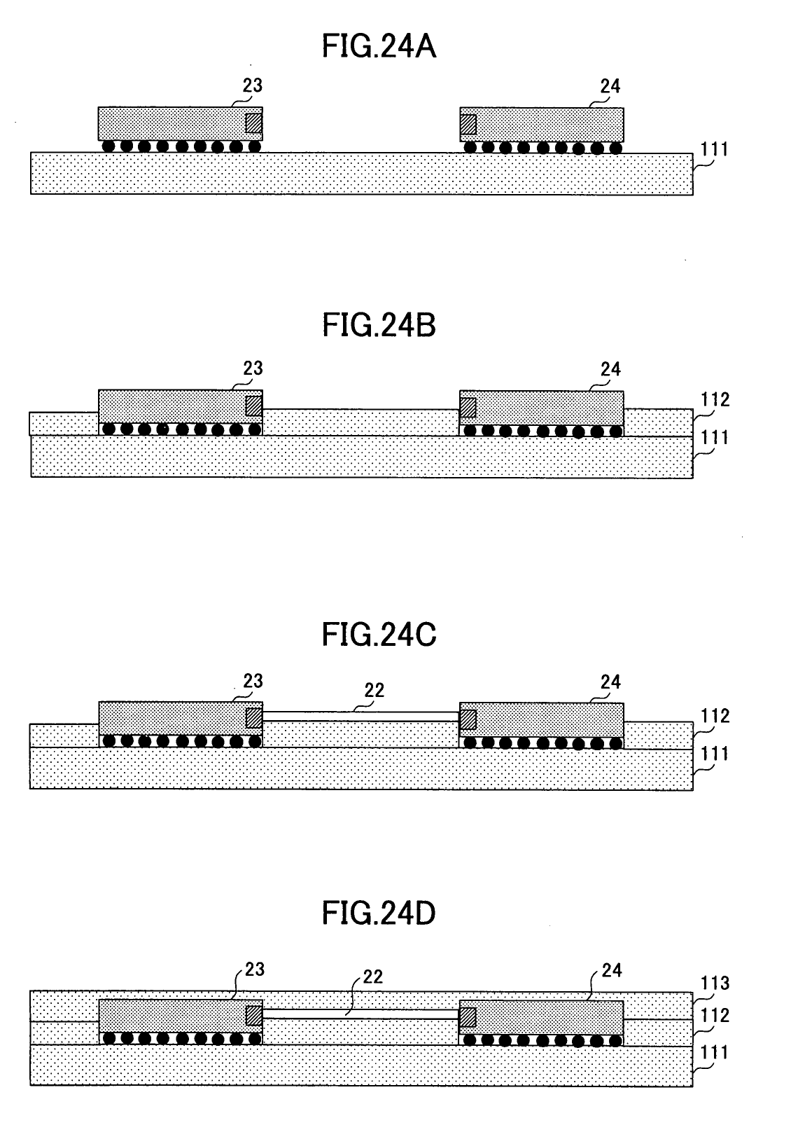

FIGS. 24A through 24D are drawings for explaining an example of a method of optically coupling optical devices according to the present invention. In FIGS. 24A through 24D, the same elements as those of FIG. 1 are referred to by the same numerals, and a description thereof will be omitted.

As shown in FIG. 24A, the optical device 23 and the optical device 24 are implemented on a substrate 111. The optical devices 23 and 24 are electrically connected to the substrate 111 by utilizing a conventional electrical coupling structure such as a BGA structure.

As shown in FIG. 24B, a substrate 112 is stacked on the substrate 111. The substrate 112 has through holes having lengths and widths matching those of the optical devices 23 and 24 at the positions of the optical device 23 and the optical device 24, so that the optical device 23 and the optical device 24 are fit in these through holes. The substrate 112 may be a single substrate, or may alternatively be a multi-layered substrate formed by stacking a plurality of thin substrates on the substrate 111 one after another.

As shown in FIG. 24C, then, the optical transmission channel 22 is formed on the top surface of the substrate 112 after the elevation of the top surface of the substrate 112 becomes aligned with the elevation of the point of light emission/reception of the optical device 23. This is done by disposing an optical fiber on the top surface of the substrate 112.

As shown in FIG. 24D, then, a substrate 113 is stacked on the substrate 112. The substrate 113 has through holes having lengths and widths matching those of the optical devices 23 and 24 at the positions of the optical device 23 and the optical device 24, so that the optical device 23 and the optical device 24 are fit in these through holes. The substrate 113 may be a single substrate, or may alternatively be a multi-layered substrate formed by stacking a plurality of thin substrates on the substrate 112 one after another. With respect to layers positioned above the height of the optical device 23 and the optical device 24, substrates having no through holes may be stacked one after another.

The process step shown in FIG. 24D is optional, and does not have to be performed. In such a case, a circuit board module having the same configuration as shown in FIG. 6 is obtained. The stacking of the substrates 113 may be stopped as appropriate once the optical transmission channel 22 is buried in the multi-layered substrate by stacking the substrates 113 on the substrate 112. If the stacking of the substrates 113 is stopped before the optical device 23 and the optical device 24 are buried, a circuit board module having the same configuration as that shown in FIG. 2 is obtained, for example.

In this manner, a circuit board module of the present invention may be manufactured by stacking substrates after mounting the optical device 23 and the optical device 24. Alternatively, as described in connection with FIG. 2 and FIG. 6, for example, a substrate having preformed recesses may be prepared, and optical devices may be fit in these recesses to manufacture the circuit board module.

Further, the present invention is not limited to these embodiments, but various variations and modifications may be made without departing from the scope of the present invention.

What is claimed is:

1. A circuit board, comprising:
a substrate having a thickness in a first direction, extending in a plane perpendicular to the first direction, and having at least one of a through hole and a recess; and
an optical transmission channel having an end thereof at a perimeter of the one of a through hole and a recess and having a portion thereof extending a predetermined distance from the end in a direction substantially perpendicular to the first direction, the portion being provided in the substrate or on a surface of the substrate.

2. The circuit board as claimed in claim 1, further comprising a semiconductor device positioned in the first direction by being fit in the one of a through hole and a recess of the substrate and transmitting/receiving light in a second direction substantially perpendicular to the first direction, a position of light transmission/reception of the semiconductor device being aligned with a position of the end of the optical transmission channel.

3. The circuit board as claimed in claim 2, wherein the optical device is positioned in the first direction by a perimeter surface of the through hole or a bottom surface of the recess.

4. The circuit board as claimed in claim 1, wherein the optical transmission channel is disposed to curve at least in the first direction.

5. The circuit board as claimed in claim 1, wherein the substrate has another through hole, and wherein the optical transmission channel extends in a direction substantially perpendicular to the first direction in the substrate or on the surface of the substrate, and passes through said another through hole so as to extend in the first direction in said another through hole.

6. The circuit board as claimed in claim 2, wherein the semiconductor device includes:
a first semiconductor device configured to operate based on electrical signals without using optical signals; and
a second semiconductor device electrically connected to the first semiconductor device and configured to convert electrical signals exchanged with the first semiconductor device into optical signals for light transmission/reception.

7. The circuit board as claimed in claim 2, further comprising an electronic device electrically connected to the semiconductor device, wherein the electronic device is configured to operate based on electrical signals without using optical signals, and the semiconductor device is configured to convert electrical signals exchanged with the electronic device into optical signals for light transmission/reception.

8. The circuit board as claimed in claim 7, wherein the electronic device and the semiconductor device are disposed such that circuit faces thereof face each other.

9. A method of optically coupling semiconductor devices, comprising the steps of:
mounting on a substrate at least two semiconductor devices transmitting/receiving light in a lateral direction at a predetermined height position relative to a top surface of the substrate;
disposing on the substrate an integrally formed member including a platform and an optical transmission channel formed on a top surface of the platform so as to position the optical transmission channel at the predetermined height position relative to the top surface of the substrate; and
optically coupling between the two semiconductor devices through the optical transmission channel.

10. A method of optically coupling semiconductor devices, comprising the steps of:
mounting on a first substrate at least two semiconductor devices transmitting/receiving light in a lateral direction at a predetermined height position relative to a top surface of the first substrate;
stacking one or more second substrates on the first substrate;
providing an optical transmission channel on a top surface of the one or more stacked second substrates so as to position the optical transmission channel at the predetermined height position relative to the top surface of the first substrate; and
optically coupling between the two semiconductor devices through the optical transmission channel.
